(19) United States
(12) Patent Application Publication
(10) Pub. No.: US 2025/0269932 A1
(43) Pub. Date: Aug. 28, 2025

(54) BICYCLE TRANSMISSION

(71) Applicant: CLASSIFIED CYCLING BV, Antwerpen (BE)

(72) Inventor: Roëll Marie VAN DRUTEN, Eindhoven (NL)

(21) Appl. No.: 18/858,127

(22) PCT Filed: Apr. 19, 2023
(86) PCT No.: PCT/EP2023/060203

§ 371 Date: Oct. 18, 2024

(30) Foreign Application Priority Data
Apr. 19, 2022 (NL) 2031622
Apr. 25, 2022 (WO) PCT/EP2022/060913
Nov. 28, 2022 (WO) PCT/EP2022/083546
Feb. 27, 2023 (NL) 2034230

(51) Int. Cl. B62M 11/14; B62J 6/015; B62M 6/55; B62M 9/00; B62M 11/16; B62M 11/18; B62M 25/08

(52) U.S. Cl. CPC B62M 11/145; B62J 6/015; B62M 6/55; B62M 9/00; B62M 11/18; B62M 25/08; B62M 11/16

(57) ABSTRACT

The disclosure relates to a bicycle transmission, comprising a transmission input and a transmission output, each associated with a first axis, and a second axis offset from the first axis. The bicycle transmission comprises a parallel transmission providing a parallel transmission stage between a parallel transmission input associated with the first axis and a parallel transmission output associated with the second axis. The bicycle transmission further comprises a planetary transmission associated with the second axis.

### FIELD

The invention relates to a transmission for a bicycle

### BACKGROUND

Bicycles typically include a transmission that is selectively operable according to multiple transmission ratios. Bicycle hub transmissions are known where a gear shifting mechanism is accommodated by the wheel hub of a driven wheel of the bicycle. Bicycle crank transmissions are also known where a gear shifting mechanism is accommodated by a housing at or near the crank of the bicycle. Some bicycles may include an electric propulsion motor. An output torque of the electric propulsion motor, which can be relatively substantial, may in some instances be transmitted through the bicycle transmission, thus increasing the overall load on the bicycle transmission.

### SUMMARY

It is a general aim to provide a durable and mechanically efficient bicycle transmission, that is lightweight and producible at minimum cost. It is furthermore an aim to provide a bicycle transmission that is capable of shifting gears under load, preferably in an energy efficient manner.

According to an aspect, a bicycle transmission is provided, comprising a transmission input associated with a first axis and a transmission output associated with a second axis offset from the first axis. The bicycle transmission comprises a parallel transmission providing a parallel transmission stage between a parallel transmission input associated with the first axis and a parallel transmission output associated with the second axis. The bicycle transmission further comprises a planetary transmission. The planetary transmission provides a planetary transmission stage between a planetary transmission input associated with the second axis and a planetary transmission output associated with the second axis, wherein the planetary transmission is arranged for providing the planetary transmission stage to selectively have one of a plurality of different transmission ratios. The bicycle transmission comprises a clutch mechanism. The clutch mechanism is arranged for selectively clutching one or more rotational members of the planetary transmission to a stationary part, for selectively transmitting torque by the planetary transmission according to the one of the plurality of different transmission ratios. By having the planetary transmission associated with the second axis, in a transmission path after the parallel transmission, mechanical loads on the planetary transmission may be minimized. This may improve durability and overall efficiency of the bicycle transmission. Furthermore, by having the first and second axis offset, the clutch mechanism may be conveniently accessible for shifting gears with the planetary transmission.

Optionally, the first axis has no transmission outputs associated therewith. Particularly, the first axis has no geared transmission outputs associated therewith. Hence, the first axis may only be associated with transmission inputs, such as with the parallel transmission input, for providing a parallel transmission stage to the second axis. The bicycle transmission may hence be free of transmissions, such as planetary transmissions, that provide a transmission stage from an input associated with the first axis to an output associated with the first axis.

Optionally, the bicycle transmission is free of further parallel transmissions. Hence, the planetary transmission may not include another parallel transmission that provides another parallel transmission stage between a parallel transmission input associated with the second axis and a parallel transmission output associated with the first axis. The bicycle transmission may hence receive a torque input about the first axis, transfer the torque by a parallel transmission stage from the first axis to the second axis, and outputting the transmitted torque about the second axis to driven element, such as a chain wheel.

Optionally, the bicycle transmission may comprise a continuously variable transmission. If the bicycle transmission comprises the continuously variable transmission, it is associated with the second axis, and arranged in series with the parallel transmission. If the bicycle transmission comprises both the planetary transmission and the continuously variable transmission, the planetary transmission and the continuously variable transmission may be arranged in series with each other. Advantageously, the continuously variable transmission may be arranged at an input side of the planetary transmission, i.e. in a transmission path between the parallel transmission and the planetary transmission.

The bicycle transmission may comprise a first axle that extends along the first axis. The bicycle transmission may comprise a second axle that extends along the second axis. The second axle may hence be offset from the first axle. The first axle may be considered an input axle or primary axle of the bicycle transmission. The second axle may be considered a secondary axle, lay axle, or output axle of the bicycle transmission. In an example, the second axle may be kept stationary, e.g. relative to a transmission housing. The second axle may for instance form the stationary part. The first axle may be a rotatable axle or a non-rotatable axle, e.g. relative to a transmission housing.

Optionally, the planetary transmission has three rotational members, wherein the clutch mechanism is arranged for clutching one of the rotational members to a stationary part. The one of the rotational members may hence be selectively non-rotatably fixable to the stationary part. The three rotational members may include a ring gear, a planet carrier carrying one or more planet gears, and a sun gear. One of the these rotational members may be clutchable to the stationary part by the clutch mechanism. The stationary part may for example be a transmission housing of the bicycle transmission or a stationary axle, e.g. the second axle, of the bicycle transmission.

Optionally, the planetary gear set of the planetary transmission is a sunless planetary gear set with only one planet carrier carrying one or more planet gears, and two ring gears. Optionally, the only one planet carrier is selectively clutchable to the stationary part by the clutch mechanism.

Optionally, the planetary gear set of the planetary transmission is a ringless planetary gear set with only one planet carrier carrying one or more planet gears, and two sun gears. Optionally, the only one planet carrier is selectively clutchable to the stationary part by the clutch mechanism.

Optionally, the one or more planet gears of the planetary transmission are stepped planet gears including a large-radius gear part and a small-radius gear part rotationally fixed to each other.

Optionally, each planet radius cooperates with a respective sun gear or ring gear, and wherein the clutch mechanism is arranged for selectively clutching one of the cooperating sun gears or ring gears to the stationary part for transmitting torque according to a selective one of the plurality of transmission ratios.

Optionally, the planetary transmission comprises a plurality of sun gears, and wherein the one or more planet gears are stepped planet gears each including a plurality of different planet radii, wherein each sun gear cooperates with the stepped planet gear at a respective radius of the plurality of different radii.

Optionally, the stepped planet gear comprises at least three different planet radii, such as at least four different planet radii.

Optionally, the clutch mechanism comprises one or more actuatable clutches.

Optionally, each actuatable clutch is associated with a respective sun gear and arranged for selectively coupling and/or decoupling the respective sun gear to the stationary part.

Optionally, the stepped planet gear includes two, e.g. identical, small-radius gears parts rotationally fixed to the large-radius gear part on opposite sides of the large-radius gear part. A symmetric planet gear can hence be obtained, enabling effective support for the stepped planet gear. The large-radius gear part may for example mesh with the ring gear, such that torque can be transferred from the planet carrier to the ring gear via the large-radius planet gear part, wherein the two small-radius planet gear parts on opposing sides of the large-radius planet gear part for example mesh with respective sun gear parts of the single-diameter sun gear. A robust yet compact setup can hence be obtained.

Optionally, the clutch mechanism comprises a rotatable cam shaft that extends along the second axis and is arranged for selectively actuating the one or more actuatable clutches by a rotation of the rotatable cam shaft about the second axis relative to the stationary part

Optionally, the one or more actuatable clutches are form closed clutches, configured for transferring torque in at least one rotation direction. In general, any actuatable clutch described herein may be a form closed clutch, configured for transferring torque in at least one rotation direction.

Optionally, each of the actuatable clutchs is configured for being coupled and decoupled under load. In general, any actuatable clutch described herein may be configured for being coupled and decoupled under load.

Optionally, each actuatable clutch is independently actuatable.

Optionally, the one or more actuatable clutches are identical to each other. Hence, the bicycle may include a single type of actuatable clutch.

Optionally, the planetary transmission is selectively operable according to a unitary transmission ratio. Optionally, the planetary transmission is selectively operable according to a speed-increasing transmission ratio. Optionally, the planetary transmission is selectively operable according to a speed-decreasing transmission ratio. Optionally, the speed-increasing transmission ratio and the speed-decreasing transmission ratio of the planetary transmission are inverse to each other. For any of the actuatable clutches described herein, it may hold that, optionally, the actuatable clutch has a clutch input, and a clutch output, the actuatable clutch including:

a first unit connectable to the clutch input, including a gripping member having at least one first abutment surface;

a second unit connectable to the clutch output, including at least one second abutment surface arranged for selectively engaging the first abutment surface, the first and second abutment surfaces being adapted to each other so as to allow disengaging under load, preferably in two directions;

a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, e.g. in two directions, and in the second mode releases the at least one second abutment surface for decoupling the second unit from the first unit. The bicycle transmission including such actuatable clutch (or actuatable clutches) can be manufactured in a small form-factor suitable for integration in a two-wheeled bicycle.

Optionally, the actuatable clutch comprises a bearing, such as a rolling-contact bearing or a sliding-contact bearing between the at least one retaining member and the at least one gripping member.

Optionally, the actuatable clutch includes an actuator for moving the third unit from a first position to a second position or from a second position to a first position relative to the second rotatable unit.

Optionally, the third unit includes at least one actuation member arranged for moving the third unit from a first position to a second position or from a second position to a first position relative to the second rotatable unit.

Optionally, the actuatable clutch includes a first rotatable unit connectable to the input; a second rotatable unit connectable to the output; a third rotatable unit arranged for co-rotating with the second rotatable unit, the third rotatable unit being arranged for selectively being in a first rotational position or a second rotational position relative to the second rotatable unit, wherein the actuatable clutch is arranged for selectively in the first rotational position rotationally coupling the second rotatable unit to the first rotatable unit, and in the second rotational position decoupling the second rotatable unit from the first rotatable unit; wherein the actuatable clutch is arranged for temporarily changing rotation speed of the third rotatable unit relative to the second rotatable unit for rotating from the first position to the second position, or from the second position to the first position.

Optionally, any one or more of the first unit, the second unit, and the third unit of the actuatable clutch are associated with the second axis. For example, the first unit, the second unit, and the third unit of the actuatable clutch may be rotatable about the second axis.

Optionally, any actuatable clutch described herein may or example be similar or identical to a clutch as described in WO2018/199757A2, WO2020/085911A2, or WO2021/080431A1, the contents of which are incorporated herein in its entirety.

Optionally, the parallel transmission stage is formed by a cooperating gear pair having a primary gear being rotatable about the first axis and a secondary gear being rotatable about the second axis.

Optionally, the primary gear and the secondary gear of the cooperating gear pair cooperate with one another meshingly, or wherein the primary gear and the secondary gear of the cooperating gear pair cooperate with one another non-meshingly, such as via a respective endless driver member, e.g. a chain or belt. Optionally, the parallel transmission is a non-shiftable transmission that is operable according to a single fixed transmission ratio.

Optionally, the parallel transmission is arranged for providing the parallel transmission stage to selectively have one of a plurality of different parallel transmission ratios. The parallel transmission may for example comprise multiple cooperating gear pairs, wherein torque is selectively transferred from through any one of the cooperating gear pairs.

Optionally, the parallel transmission comprises an actuatable clutch for switching the parallel transmission from one of the plurality of parallel transmission ratios to another, and/or vice versa.

Optionally, the actuatable clutch for actuating the parallel transmission is associated with the second axis. Clutch members of the actuatable clutch may for example be rotatable about the second axis, or coupled or couplable to the second axle.

Optionally, each of the actuatable clutches described herein are associated with the second axis.

Optionally, the parallel transmission stage is selectively formed by a first cooperating gear pair arranged in a first transmission path, or a second cooperating gear pair arranged in a second transmission path parallel to the first transmission path, wherein each of the first and second cooperating gear pair has a primary gear being rotatable about the first axis and a secondary gear being rotatable about the second axis, the first actuatable clutch being arranged for selectively enabling a torque transmission from the parallel transmission input to the parallel transmission output through any one of the first transmission path or the second transmission path.

Optionally, the primary gear and the secondary gear of each of the first and/or second cooperating gear pair cooperate with one another meshingly. Alternatively, optionally, the primary gear and the secondary gear of each of the first and/or second cooperating gear pair cooperate with one another non-meshingly, such as via a respective endless driver member, e.g. a chain or belt.

Optionally, the bicycle transmission comprises a continuously variable transmission (CVT) providing a CVT transmission stage between a CVT transmission input associated with the second axis and a CVT transmission output associated with the second axis.

Optionally, the continuously variable transmission (CVT) includes

a first drive element rotatable about a first CVT axis; a second drive element rotatable about a second CVT axis, the first drive element being movable relative to the second drive element in a direction transverse to the first CVT axis and the second CVT axis; coupling elements provided at a constant first radius from the first CVT axis and at a variable second radius from the second CVT axis, or at a constant first radius from the second CVT axis and at a variable second radius from the first CVT axis, for transferring torque between the first drive element and the second drive element. The first drive element and the second drive element are movable relative to each other in a direction transverse to the first CVT axis and second CVT axis for transferring torque at different transmission ratios. By varying the relative displacement between the first drive element being associated with the first CVT axis, and the second drive element being associated with the second CVT axis, the variable second radius at which torque is transferred between the input and second drive elements is varied. Hence, various transmission ratios can be obtained between the first drive element and the second drive element. The CVT can be made into a relative small form factor, with a relatively few components and small mass.

Optionally, the coupling elements are coupled to the second drive element in a tangential direction, and movable relative to the second drive element in a radial direction, wherein the coupling elements are coupled to the First drive element in a radial direction at the first radius from the first CVT axis, and movable relative to the First drive element in a first tangential direction, and wherein the coupling elements are couplable to the First drive element in a second tangential direction opposite the first tangential direction. Thus, the coupling elements can be maintained at a predetermined radial distance relative to the first CVT axis. The coupling elements can e.g. be freely movable in the first tangential direction relative to the first drive element and couple to the first drive element in the second tangential direction relative to the first drive element. Hence, the first drive element can drive the coupling elements in rotation in the first tangential direction, and the first drive element can freely move in the second tangential direction relative to the coupling elements. Also, the coupling elements can drive the first drive element in rotation in the second tangential direction, and the coupling elements can freely move in the first tangential direction relative to the first drive element.

Optionally, the second CVT axis coincides with the second axis, and wherein the First drive element is movable relative to the second drive element to an eccentric position offset from the second axis.

Optionally, the first drive element is pivotally movable about a pivot axis that extends parallel to the first CVT axis, for being pivotally moved relative to the second drive element in a direction transverse to the first CVT axis.

Optionally, the first drive element comprises a first concentric guide extending concentrically around the first CVT axis, wherein the first concentric guide is arranged for guiding a movement of the coupling elements in the first tangential direction. The first concentric guide may for example be a slot provided in the first drive element, which slot concentrically extends around the first CVT axis.

Optionally, the first concentric guide and the coupling elements form or include a one-way coupling for allowing movement of the coupling elements relative to the first concentric guide in the first tangential direction, and for blocking movement of the coupling elements relative to the first concentric guide in the second tangential direction. The one-way coupling may for example be wedging or ratcheting coupling. Each of the coupling elements may for example comprise a one-way unit which is arranged to be wedged between an inner race and an outer race of the first concentric guide when driven in the second tangential direction.

Optionally, each of the coupling elements comprises a wedging body which is tiltable about a tilt axis between a neutral position in which free movement of the coupling element relative to the first concentric guide is allowed, and a wedged position in which the wedging body is wedgingly engaged with the first concentric guide. For example the wedging body may be wedged between two races of the first concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the coupling elements comprises at least one roller for activating the tilting of the wedging body from the neutral position to the wedged position.

Optionally, a first end of the wedging body is provided with a converging wedging recess for cooperating with a first roller and a second end of the wedging body, opposite the first end, is provided with a diverging wedging recess for cooperating with a second roller. Here converging and diverging are defined as seen in a direction away from the centre of the wedging body. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the first concentric guide and a converging wedging face of the converging wedging recess. The second roller may for example be provided between an outer race of the first concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises first radial guides extending at least radially with respect to the second CVT axis, i.e. having a radial component. The first radial guides are arranged for guiding movement of the coupling elements in radial direction and for transmitting torque in tangential direction. The first radial guides may comprise radially extending slots in a body of the second drive element.

Optionally, each of the coupling elements comprises a guide wheel for running along the first radial guides.

Optionally, the coupling elements are movably, such as hingedly, connected to the second drive element for allowing a radial movement of the coupling elements relative to the second drive element.

Optionally, each wedging body is tiltable about a tilt axis between a neutral position in which free movement of the coupling element relative to the first concentric guide is allowed, and a wedged position in which each wedging body is wedgingly engaged with the first concentric guide.

Optionally, each of the coupling elements comprises two wedging bodies. Optionally, each wedging body of the first coupling element is tiltable about a common tilt axis between a neutral position in which free movement of the coupling element relative to the first concentric guide is allowed, and a wedged position in which each wedging body is wedgingly engaged with the first concentric guide.

Optionally, the guide wheel is rotatable about the common tilt axis, wherein the two wedging bodies are arranged on either side of the guide wheel.

Optionally, the transmission is arranged for pivoting the first drive element about the pivot axis between a first extreme position and a second extreme position, e.g. between a concentric position in which the first CVT axis coincides with the second CVT axis and an eccentric position in which the first CVT axis is offset from the second CVT axis.

Optionally, the first drive element is pivotable about the pivot axis to a selective position within a continuous pivot range defined between the first extreme position and the second extreme position, e.g. between the concentric position and the eccentric position, wherein the continuous pivot range is symmetrical with respect to a horizontal plane through the pivot axis.

Optionally, the first drive element of the CVT is fixed to or integrated with the secondary gear of the parallel transmission stage.

Optionally, the primary gear and the secondary gear of the parallel transmission stage cooperate with one another non-meshingly, such as via an endless drive member. Hence, movement of the first drive element relative to the second drive element is facilitated.

Optionally, the continuously variable transmission comprises a third drive element that is rotatable about a third axis parallel to the second axis. The third drive element and the second drive element can be movable relative to each other in a direction transverse to the third and second axis. The CVT can include second coupling elements provided at a constant third radius from the third axis and at a variable fourth radius from the second axis, for transferring torque between the third drive element and the second drive element. Hence, torque can be transmitted from the first drive element to the second drive element according to a first CVT transmission ratio, and from the second drive element to the third drive element according to a second CVT transmission ratio. The first and second CVT transmission ratios are particularly serially arranged, and hence a CVT unit transmission ratio step obtainable with the CVT unit can be increased. Optionally, the constant first radius corresponds to the constant third radius, i.e. the constant first radius and the constant third radius are equal. Optionally, the variable second radius corresponds to the variable fourth radius, i.e. the variable second radius and the variable fourth radius are equal.

Optionally, the second coupling elements are coupled to the second drive element in a tangential direction, and movable relative to the second drive element in a radial direction. Thus, the second coupling elements can move radially relative to the second axis, while remaining tangentially coupled to the third drive element. Optionally, the second coupling elements are coupled to the third drive element in a radial direction at the constant third radius, and movable relative to the third drive element in a fourth tangential direction. Optionally the second coupling elements are couplable to the third drive element in a third tangential direction opposite the fourth tangential direction. Optionally, the third tangential direction corresponds to the first tangential direction, i.e. the third and first tangential directions are the same. Optionally, the fourth tangential direction corresponds to the second tangential direction, i.e. the fourth and second tangential directions are the same. Thus, the second coupling elements can be coupled to the third drive element in a radial direction at the third radius, and movable relative to the third drive element in the second tangential direction, and the second coupling elements are couplable to the third drive element in the first tangential direction. Hence, the second coupling elements can drive the third drive element in rotation in the first tangential direction, and the second coupling elements can freely move in the second tangential direction relative to the third drive element. Also, the third drive element can drive the second coupling elements in rotation in the second tangential direction, and the third drive element can freely move in the first tangential direction relative to the second coupling elements.

Optionally, the third drive element comprises a second concentric guide extending concentrically around the third axis, wherein the second concentric guide is arranged for guiding a movement of the second coupling elements in the third tangential direction. The second concentric guide may for example be a slot provided in the third drive element, which slot concentrically extends around the third axis.

Optionally, the second concentric guide and the second coupling elements form or include a one-way coupling for allowing movement of the second coupling elements relative to the second concentric guide in the fourth tangential direction, and for blocking movement of the second coupling elements relative to the second concentric guide in the third tangential direction.

Optionally, each of the second coupling elements comprises a wedging body which is tiltable about a tilt axis between a neutral position in which free movement of the coupling element relative to the first concentric guide is allowed, and a wedged position in which the wedging body is wedgingly engaged with the second concentric guide. For example the wedging body may be wedged between two races of the second concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the second coupling elements comprises at least one roller for activating the tilting of the wedging body from the neutral position to the wedged position.

Optionally, a first end of the wedging body is provided with a converging wedging recess for cooperating with a first roller and at a second end of the wedging body, opposite the first end, is provided with a diverging wedging recess for cooperating with a second roller. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the second concentric guide and a converging wedging face of the converging wedging recess. The second roller may for example be provided between an outer race of the second concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises second radial guides extending radially with respect to the second axis, wherein the second radial guides are arranged for guiding movement of the second coupling elements in radial direction and for transmitting torque in tangential direction. The second radial guides may comprise radially extending slots in a body of the second drive element.

Optionally, each of the second coupling elements comprises a guide wheel for running along the second radial guides.

Optionally, the second coupling elements are movably, such as hingedly, connected to the second drive element for allowing a radial movement of the second coupling elements relative to the second drive element.

Optionally, each wedging body is tiltable about a tilt axis between a neutral position in which free movement of the coupling element relative to the second concentric guide is allowed, and a wedged position in which each wedging body is wedgingly engaged with the second concentric guide.

Optionally, each of the second coupling elements comprises two wedging bodies. Optionally, each wedging body of the second coupling element is tiltable about a common tilt axis between a neutral position in which free movement of the coupling element relative to the second concentric guide is allowed, and a wedged position in which each wedging body is wedgingly engaged with the second concentric guide.

Optionally, the guide wheel is rotatable about the common tilt axis, wherein the two wedging bodies are arranged on either side of the guide wheel.

Optionally, the first axis and the third axis coincide. The first drive element and the third drive element may for example be rotatable about a common axis.

Optionally, the second drive element is pivotally movable about a pivot axis that extends parallel to the first and second axes, for being pivotally moved relative to the first drive element in a direction transverse to the first and second axis. Hence, the second drive element can be moved relative to the first drive element by a rotary drive about the pivot axis.

Optionally the continuously variable transmission comprises a second transmission wheel concentrically coupled to the second drive element and corotatable therewith about the second axis; and a parallel transmission wheel drivingly connected to the second transmission wheel for transmitting torque between the first and second transmission wheels, wherein the parallel transmission wheel has a rotation axis that coincides with the pivot axis. The parallel transmission wheel and the second transmission wheel may for example be a first gear wheel and a second gear wheel respectively, wherein the first and second gear wheels mesh for transferring torque. The parallel transmission wheel and the second transmission wheel may alternatively be a first chain wheel and a second chain wheel respectively, connected via a chain.

Optionally, the continuously variable transmission comprises an endless drive member, e.g. a chain or belt, drivingly engaging the parallel transmission wheel and the second transmission wheel for transmitting torque between the first and second transmission wheels. A gearless transmission can hence be obtained. Also, for example, when driving the first drive member in rotation about the first axis, the driving force is transferred by the first coupling elements to the second drive element. This force acts on the second drive element in substantially opposite direction as a reaction force from the endless drive member. Hence, an actuation force for moving the second drive element relative to the first drive element can be reduced, at least with respect to a geared drive arrangement.

Optionally, the continuously variable transmission is arranged for pivoting the second drive element between a concentric position in which the first and second axes coincide and an eccentric position in which the first and second axes are offset, and wherein if the first drive element drives the second drive element in a driven rotation direction about the second axis the continuously variable transmission is arranged for pivoting the second drive element from the concentric position to the eccentric position in a rotation direction about the pivot axis opposite the driven rotation direction; and if the second drive element drives the first drive element in a driven rotation direction about the first axis the continuously variable transmission is arranged for pivoting the second drive element from the concentric position to the eccentric position in the driven rotation direction about the pivot axis. Hence, an actuation force for moving the second drive element relative to the first drive element can be minimised.

Optionally, e.g. alternatively, or additionally, the first drive element is pivotally movable about a pivot axis that extends parallel to the first and second axes, for being pivotally moved relative to the second drive element in a direction transverse to the first and second axis. Then the continuously variable transmission can arranged for pivoting the first drive element between a concentric position in which the first and second axes coincide and an eccentric position in which the first and second axes are offset, and wherein if the second drive element drives the first drive element in a driven rotation direction about the second axis the continuously variable transmission is arranged for pivoting the first drive element from the concentric position to the eccentric position in a rotation direction about the pivot axis opposite the driven rotation direction; and if the first drive element drives the second drive element in a driven rotation direction about the first axis the continuously variable transmission is arranged for pivoting the first drive element from the concentric position to the eccentric position in the driven rotation direction about the pivot axis. Hence, an actuation force for moving the first drive element relative to the second drive element can be minimised.

Optionally, the continuously variable transmission comprises a pivot arm for coupling the parallel transmission wheel to the second transmission wheel and delineate a constant distance between the second axis and the pivot axis, the pivot arm extending between a first end at which the pivot arm couples to the parallel transmission wheel at the pivot axis, and a second end at which the pivot arm couples to the second transmission wheel at the second axis. Because, the parallel transmission wheel is rotatingly associated with the pivot axis, and the second transmission wheel with the second axis, the first and second transmission wheel can remain drivingly engaged while pivoting second transmission wheel along with the second drive member relative to the parallel transmission wheel, e.g. directly meshingly engaged or via an endless drive member such as a belt or chain.

Optionally, the continuously variable transmission comprises a fourth transmission wheel concentrically coupled to the second drive element and corotatable therewith about the second axis; and a third transmission wheel drivingly connected to the fourth transmission wheel for transmitting torque between the third and fourth transmission wheels, wherein the third transmission wheel has a rotation axis that coincides with the pivot axis.

Optionally, the continuously variable transmission may be similar to the CVT as disclosed in co-pending patent application PCT/EP 1022/060920, which is incorporated by reference in its entirety.

Optionally, the bicycle transmission comprises a transmission housing holding the parallel transmission and the planetary transmission and/or the continuously variable transmission. The housing can seal components of the bicycle transmission from the surroundings. The housing for example delimits a sealed cavity in which the parallel transmission and the planetary transmission are provided, and optionally also the continuously variable transmission.

Optionally, the bicycle transmission comprises an electric propulsion motor arranged for driving the parallel transmission input about the first axis. The electric propulsion motor may for instance have a motor output axis coinciding with the first axis. Optionally, the bicycle transmission comprises an electric propulsion motor having a motor output axis coinciding with the second axis.

Optionally, the electric propulsion motor is configured for outputting a maximum output power of at most 10 kW, preferably at most 4 kW. The electric propulsion motor may for example have power rating of at most 10 kW, preferably at most 4 kW.

Optionally, the electric propulsion motor is held by the transmission housing.

Optionally, the bicycle transmission comprising a crank connected to the transmission input for being rotatably drivable about the first axis. The crank may hence be connected to the first axle, e.g. corotating with the first axle about the first axis. A chain ring may be connected to the transmission output for being rotatably drivable about the second axis. The chain ring may hence be rotatably connected to the, e.g. stationary, second axle.

Another aspect provides a transmission module for a modular bicycle transmission comprising: a planetary transmission providing a planetary transmission stage between a planetary transmission input adapted for being associated with a stationary axle and a planetary transmission output adapted for being associated with the stationary axle, wherein the planetary transmission is arranged for providing the planetary transmission stage to selectively have one of a plurality of different transmission ratios; and a clutch mechanism adapted for being associated with the stationary axle, and arranged for selectively clutching one or more rotational members of the planetary transmission to the stationary axle, for selectively transmitting torque by the planetary transmission according to the one of the plurality of different transmission ratios; wherein the transmission module is adapted for being associated with a stationary wheel hub axle and with a stationary crank axle.

An aspect provides a modular bicycle transmission system, comprising a wheel hub transmission having a stationary hub axle and a transmission module as described herein, the clutch mechanism being adapted for being associated with the stationary hub axle, and arranged for selectively clutching the one or more rotational members of the planetary transmission to the stationary hub axle. The modular bicycle transmission additionally or alternatively comprises a crank transmission having a crank transmission input associated with a first axle and a crank transmission output associated with a stationary second axle offset from the first axle; a parallel transmission providing a parallel transmission stage between a parallel transmission input associated with the first axle and a parallel transmission output associated with the stationary second axle; and a transmission module according to claim 23, wherein the clutch mechanism is arranged for selectively clutching the one or more rotational members of the planetary transmission to the stationary crank axle. The hub axle and the crank axle are similar to each other, e.g. have an identical diameter, for allowing the transmission module to cooperate with the hub axle and the crank axle.

A further aspect provides a method of producing a bicycle crank transmission, comprising: providing a bicycle crank transmission including a crank transmission input associated with a first axle and a crank transmission output associated with a stationary second axle offset from the first axle; a parallel transmission providing a parallel transmission stage between a parallel transmission input associated with the first axle and a parallel transmission output associated with the stationary second axle. The method further comprises providing a bicycle wheel hub transmission including: a planetary transmission providing a planetary transmission stage between a planetary transmission input adapted for being associated with a stationary hub axle and a planetary transmission output adapted for being associated with the stationary hub axle, wherein the planetary transmission is arranged for providing the planetary transmission stage to selectively have one of a plurality of different transmission ratios; and a clutch mechanism adapted for being associated with the stationary hub axle, and arranged for selectively clutching one or more rotational members of the planetary transmission to the stationary hub axle, for selectively transmitting torque by the planetary transmission according to the one of the plurality of different transmission ratios. The method further comprises mounting the planetary transmission and the clutch mechanism of the hub transmission on the stationary second axle.

An aspect provides a a method of producing a bicycle wheel hub transmission, comprising providing a stationary wheel hub axle and providing bicycle crank transmission including: a planetary transmission providing a planetary transmission stage between a planetary transmission input associated with a stationary axle and a planetary transmission output associated with the stationary axle, wherein the planetary transmission is arranged for providing the planetary transmission stage to selectively have one of a plurality of different transmission ratios; and a clutch mechanism adapted for being associated with the stationary axle, and arranged for selectively clutching one or more rotational members of the planetary transmission to the stationary axle, for selectively transmitting torque by the planetary transmission according to the one of the plurality of different transmission ratios. The method further comprises mounting the planetary transmission and the clutch mechanism of the crank transmission on the stationary wheel hub axle.

An aspect provides a bicycle transmission system comprising a hub housing arranged for receiving a transmission module as described herein; a crank housing arranged for receiving the transmission module as described herein; and a transmission module as described herein; wherein the bicycle transmission system is so arranged that the transmission module is selectively receivable in the hub housing or the crank housing.

As aspect provides a hub housing arranged for receiving the transmission module as described herein.

An aspect provides a combination of a hub housing as described herein and a transmission module as described herein.

As aspect provides a crank housing arranged for receiving the transmission module as described herein

An aspect provides a combination of a crank housing as described herein and a transmission module as described herein.

Another aspect provides a bicycle comprising a bicycle transmission as described herein. It will be appreciated that a bicycle encompasses similar human-powered vehicles, particularly pedal-powered, such as tricycles, quadricycles, etc. The bicycle transmission may be embodied as a hub transmission of the bicycle and/or as a crank transmission of the bicycle.

According to an aspect, an electrically powered vehicle is provided, such as a light electrically powered vehicle for example an electrically powered bicycle or scooter. The electrically powered vehicle comprises a bicycle transmission as described herein, and an electric propulsion motor having an output power of maximum 10 kW, preferably maximum 4 kW; the electric propulsion motor being arranged for propelling, or assist in propelling the vehicle, wherein the propulsion motor output power is transmitted at least partly through the bicycle transmission.

It will be appreciated that any of the aspects, features and options described herein can be combined. It will particularly be appreciated that any of the aspects, features and options described in view of the bicycle transmission apply equally to the bicycle and the electrically powered vehicle, and vice versa.

### BRIEF DESCRIPTION OF THE DRAWINGS

Embodiments of the present invention will now be described in detail with reference to the accompanying drawings in which:

FIG. 1 shows a bicycle transmission, particularly a crank transmission;

FIG. 2 shows a bicycle transmission, particularly a hub transmission;

FIG. 3 shows an actuatable clutch;

FIG. 4 shows a bicycle.

### DETAILED DESCRIPTION

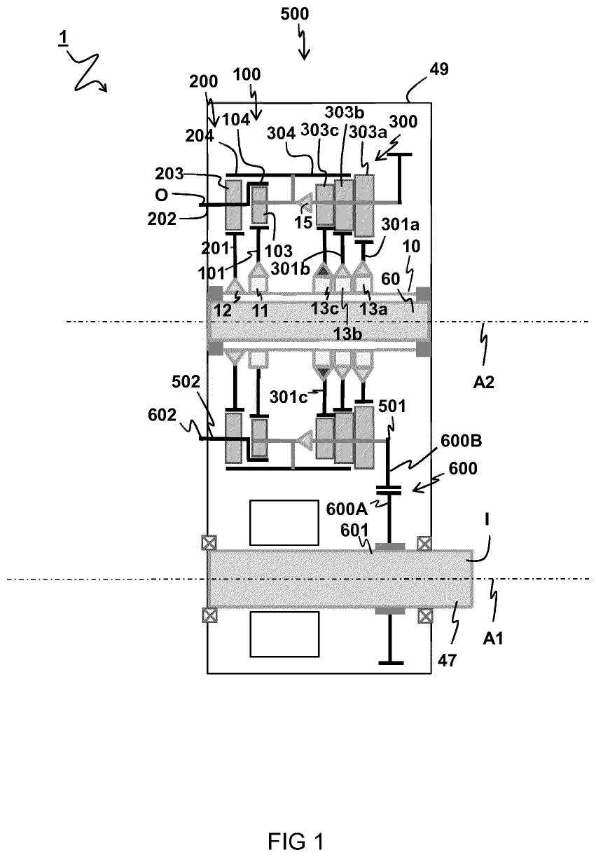

FIG. 1 shows an example of a bicycle transmission 1 having a transmission input I and a transmission output O. The bicycle transmission 1 comprises a parallel transmission 600. The parallel transmission 600 provides a parallel transmission stage between a parallel transmission input 601 associated with a first axis A1 and a parallel transmission output 602 associated with a second axis A2. The first axis A1 and the second axis A2 are offset from one another. The bicycle transmission 1 here comprises a first axle 47 that extends along the first axis A1. The first axle 47 may include multiple first axle parts that are rotatable relative to one another. The bicycle transmission 1 here also includes a second axle 10 which extends along the second axis A2. The first axle 47 and the second axle 10 are hence also offset from each other. Here the second axle 10 is a stationary axle that is non-rotatably fixed to a housing 49 of the bicycle transmission 1.

The parallel transmission 600 is in this example operable according to only one fixed transmission ratios. It will be appreciated that the parallel transmission 600 may alternatively be operable according to more than one transmission ratio, such as according to two transmission ratios. Here, the parallel transmission 600 includes a cooperating gear pair, having a primary gear 600A rotatable about the first axis A1 and a secondary gear 600B rotatable about the second axis A2. Here, the primary gear 600A of the parallel transmission 600 is mounted to the first axle 47. The first freewheel V1 is in this example associated with the first axis A1.

In the example of FIG. 1, the primary-secondary gear pair 600A, 600B of the parallel transmission 600 cooperate with one another meshingly, by a direct meshing engagement. Alternatively, the primary-secondary gear pair 600A, 600B of the parallel transmission 600 can cooperate with one another non-meshingly, e.g. via a chain or belt.

The bicycle transmission 1 further comprises, in this example, a planetary transmission 500 providing a planetary transmission stage between a planetary transmission input 501 and a planetary transmission output 502. The planetary transmission input 501 and the planetary transmission output 502 are associated with the second axis A2. The planetary transmission 500 comprises a planetary gear set having three rotational members, in particular a ring gear, a planet carrier carrying one or more planet gears and a sun gear.

The bicycle transmission system 1 shown in FIG. 1 has an exemplary planetary gear set 500 including a first planetary gear set 100 and a second planetary gear set 200. Here, each of the first and second planetary gear sets 100, 200 comprises three rotational members. The first planetary gear set 100 comprises a first sun gear 101, a first planet carrier 102 carrying one or more first planet gears 103, and a first ring gear 104. The first sun gear 101 and the first ring gear 104 mesh with the one or more first planet gears 103. The second planetary gear set 100 comprises a second sun gear 201, a second planet carrier 202 carrying one or more second planet gears 203, and a second ring gear 204. The second sun gear 201 and the second ring gear 204 mesh with the one or more second planet gears 203.

In this example, the first planet carrier 102 forms a first rotational input member of the first planetary gear set 100, and the first ring gear 104 forms the first rotational output member of the first planetary gear set 100. The first sun gear 101 forms, here, a first further rotational member of the first planetary gear set 100. In this example, the second ring gear 204 forms a second rotational input member of the second planetary gear set 200, and the second planet carrier 202 forms the second rotational output member of the second planetary gear set 200. The second sun gear 201 forms, here, a second further rotational member of the second planetary gear set 200.

The first and second rotational input members are corotatingly fixed to one another. Here, the first planet carrier 102 and the second ring gear 204 are corotatingly fixed to each other, for example integrated. The first and second rotational output members are also corotatingly fixed to one another. Here, the first ring gear 104 and the second planet carrier 202 are corotatingly fixed to each other, for example integrated. FIG. 1 shows an example where the one or more first planet gears 103 mesh with the second planet carrier 202. In an alternative configuration, the one or more second planet gears 203 may mesh with the first planet carrier 102.

The first sun gear 101 and the second sun gear 201 are, here, selectively clutchable to a stationary part. Here the stationary part is, or includes, an axle 10. Alternatively, the stationary part may be, or include, a housing. It will be appreciated that the stationary part may be, or include, other non-rotatable components of the bicycle. Hence, here, the first and second sun gears 101, 201 can be selectively braked.

The first planetary gear set 100 is arranged for transmitting torque according to an overdrive transmission ratio, i.e. increasing a rotational speed from the first planet carrier 102 to the first ring gear 104. The second planetary gear set 200 is arranged for transmitting torque according to an underdrive transmission ratio, i.e. decreasing a rotational speed from the second ring gear 204 to the second planet carrier 202.

The bicycle transmission system 1 comprises a clutch mechanism 50, arranged for, here, selectively clutching one the first sun gear 101 and the second sun gear 201 to the stationary axle 10. Hence, torque can selectively be transmitted through the first planetary gear set 100 or through the second planetary gear set 200.

In this example, the clutch mechanism comprises an first clutch 11 associated with the first planetary gear set 100. The first clutch 11 is here an active first clutch 11 configured for being actuated between a first state and a second state. In its first state, the active first clutch 11 clutches the first sun gear 101 to the stationary axle 10 in at least one rotation direction. In its second state, the active first clutch 11 unclutches the first sun gear 101 from the stationary axle 10 in the at least one rotation direction.

Here, the clutch mechanism comprises a second clutch 12 associated with the second planetary gear set 200. The second clutch 12 is in this example a passive second clutch 12, particularly a freewheel clutch. The passive second clutch 12 has only one state, and is here configured clutching the second sun gear 201 to the stationary axle 10 in one relative rotation direction and being overrun in another, opposite, relative rotation direction. The passive second clutch 12 passively clutches the second sun gear 201 to the stationary axle 10 when the first actuatable clutch 11 is in its second, unclutched, state, and is overrun when the first actuatable clutch 11 is in its first, clutched, state. Hence, in this example, the transmission system 1 can be selectively operated according to the overdrive transmission ratio or the underdrive transmission ratio, by actuation of the active first clutch 11. The passive second clutch 12 automatically clutches and unclutches the second sun gear 201, in dependence of the first actuatable clutch 11 state. The second clutch 12 may alternatively also be an active second clutch 12, for example similar to the active first clutch 11. When the active first clutch 11 and the active second clutch 12 are both in their second, unclutched, state, a neutral gear may be provided, in which no rotational power is transmittable through the first or second planetary gear set 100, 200. When the active first clutch 11 and the active second clutch 12 are both in their first, clutched, state, the transmission system 1 may be locked. Both situations can for example be used as an anti-theft feature.

In the example of FIG. 1, the planetary gear set 500 further comprises a third planetary gear set 300. The third planetary gear set 300 is arranged in series with the first and second planetary gear set 100, 200. The third planetary gear set 300 is here arranged upstream of the first and second planetary gear sets 100, 200. The third planetary gear set 300 is arranged to be selectively operated according to a plurality of different transmission ratios, here four different transmission ratios. The third planetary gear set 300 is particularly arranged to be selectively operated according to three overdrive transmission ratios and an unitary transmission ratio. Hence, here, the bicycle transmission system 1 may provide a eight-speed transmission system.

The third planetary gear set 300 includes multiple, here, three, third sun gears 301a, 301b, 301c, a planet carrier 302 carrying one or more stepped third planet gears 303, and a ring gear 304. Each third planet gear 303 includes multiple, here three, different radii 303a, 303b, 303c. Each radius 303a, 303b, 303c meshes with a respective third sun gear 301a, 301b, 301c. The third ring gear 304 meshes with a single radius 303b of the stepped third planet gears 303. The third planet carrier 302 forms a third rotational input member of the third planetary gear set 300. The third ring gear 304 forms a third rotational output member of the third planetary gear set 300. The third planet carrier 302 is clutchable to the third ring gear 304 in one relative rotation direction by a non-actuatable, passive, clutch 15, e.g. a freewheel clutch, for providing a unitary transmission ratio with the third planetary gear set 300. The third ring gear 304 is corotatingly fixed to the first planet carrier 102 and the second ring gear 204. The second ring gear 204 and the third ring gear 304 have in this example the same radius. The second ring gear 204 and the third ring gear 304 may for example be integrated as a single-radius bus.

The bicycle transmission 1 further comprises a housing 49. The housing 49 holds the parallel transmission 100 and the planetary transmission 500. The housing 49 may furthermore hold any additional transmission of the transmission system 1.

The transmission system 1 in FIG. 1 also comprises a generator 50. The generator 50 is here arranged for driving the first axle 47 in rotation about the first axis A1. The generator 50 hence, here, drives the input 601 of the parallel transmission 600.

FIG. 1 shows an example where the transmission system 1 can be used as crank transmission. Hence, the transmission input I can be coupled to a crank 1017 of the bicycle. A chainwheel 1019 may be connected to the transmission output O. The housing 49 may hence be a crank transmission housing.

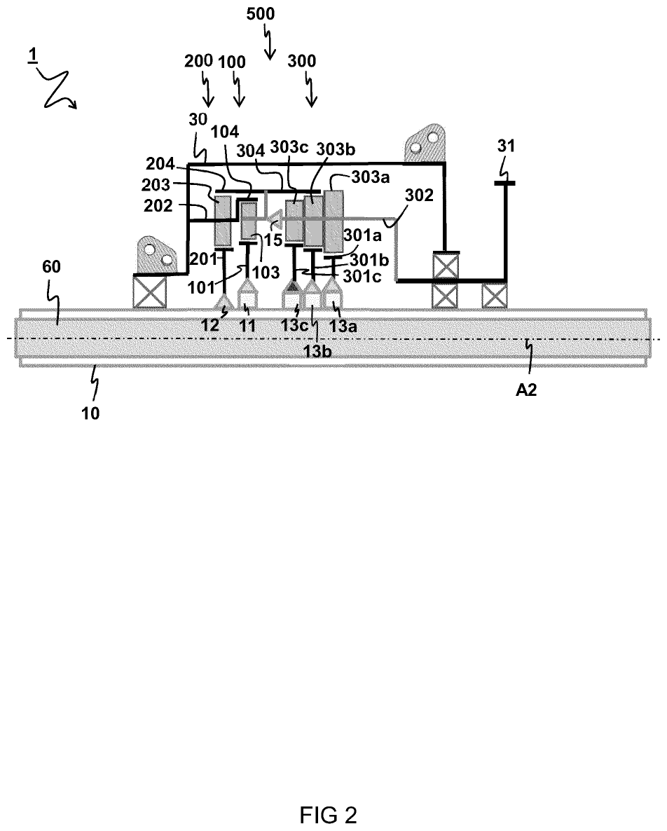

FIG. 2 shows an example of a hub transmission, comprising the planetary transmission 500 as described in view of FIG. 1. Here, the housing 49 may hence be a wheel hub shell 30, accommodating the planetary transmission 500. The hub shell 30 is coupled to, or forms, the output O of the transmission system 1. A sprocket 31 is coupled to, or forms, the input I of the transmission system 1. The sprocket 31 may engage a chain or belt, that is driven by means of a crank by a rider of the bicycle.

The actuatable clutches 11, 13a-13c can be actuated using a rotatable cam shaft 60. The cam shaft 60 in this example extends through the hollow stationary second axle 10. The cam shaft 60 may have one or more cams. By rotation of the cam shaft 60 about the second axis A2, here the hub axis, the actuatable clutches 11, 13a-13c can be controlled. The hub transmission of FIG. 2 does not comprise the parallel transmission 600, nor the first axle 47.

The planetary transmission 500 and the clutch mechanism may hence form part of a transmission module that can be used for a crank transmission as shown in FIG. 1, as well as a hub transmission as shown in FIG. 2. The transmission module may be adapted to a standard hub axle, wherein the crank transmission second axle 10 is substantially similar to a standard hub axle, for enabling mounting of the transmission module thereto.

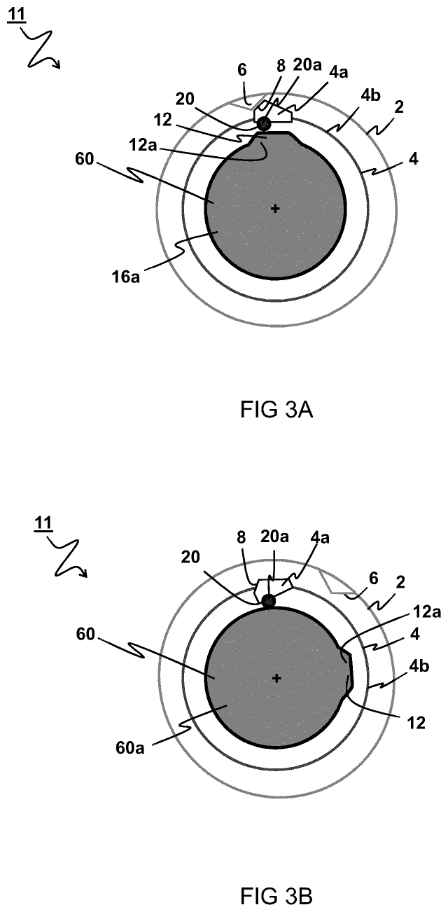

FIGS. 3A-3B show an example of an actuatable clutch 11. The clutch of FIG. 3 is given by way of example, and it will be appreciated that alternative clutches can be used in the transmission system 1 instead. The active clutch may for example be a clutch as described in co-pending Dutch application 2034230, incorporated herein by reference.

The exemplary actuatable clutch 11 has an input and an output. The input is here connected to the first sun gear 101. The output is here connected to the second axle 10. The exemplary clutch 11 is operable under load. Hence, the clutch can be coupled or decoupled under load. The clutch in FIGS. 3A-3B includes a first clutch unit 2. The first clutch unit 2, here, forms the clutch output. Here, the first clutch unit 2 is designed as a housing part of the clutch 11. The clutch 11 includes a second clutch unit 4. The second clutch unit 4, here, forms the clutch input. The first clutch unit 2 includes at least one first abutment surface 6. In this example, the first clutch unit 2 includes a plurality of first abutment surfaces 6, evenly distributed along the perimeter of the first clutch unit 2. FIGS. 3A-3B show only one first abutment surface 6 for clarity. The second clutch unit 4 includes at least one second abutment surface 8. In these examples, the second clutch unit has only one second abutment surface 8. In alternative examples however, the first clutch unit 2 may include more than one second abutment surface, such as only two second abutment surfaces, only three second abutment surfaces, only four second abutment surfaces, only five second abutment surfaces, or more than five second abutment surfaces. In an example, the second clutch unit 4 includes three second abutment surfaces 8, evenly distributed along the perimeter of the second clutch unit 4 at 120 degrees mutual spacing. In another example, the second clutch unit 4 includes two second abutment surfaces 8, evenly distributed along the perimeter of the second clutch unit 4 at 180 degrees mutual spacing. The second abutment surface 8 is here formed by a gripping member 4a. Here, the second clutch unit 4 has only one gripping member 4a, but it will be appreciated that the second clutch unit 4 may include a plurality of gripping members 4a. Here the gripping member 4a is embodied as separate parts hingedly connected to a body portion 4b of the second clutch unit 4. In this example, the second abutments surface 8 is part of the gripping member 4a of the second clutch unit 4. The second abutment surface 8, here formed by the gripping member 4a, is arranged for selectively engaging one of the first abutment surfaces 6. The first and second abutment surfaces are oriented at an angle relative to a radial direction of the first and second clutch units, respectively. This enables the first and second abutment surfaces to disengage under load.

The clutch 11 also includes a third clutch unit 60. The third clutch unit 60 is here formed by the cam shaft 60. The third clutch unit 60 includes at least one retaining member 12. In these examples, the third clutch unit 60 includes only one retaining member 12, but it will be appreciated that the third clutch unit 60 may include more than one retaining member, such as only two retaining members, only three retaining members, only four retaining members or only five retaining members, for example evenly distributed along the perimeter of the third clutch unit 60 at equal degrees mutual spacing. The third clutch unit 60 is arranged for selectively being in a first position as shown in FIG. 3A or a second position as shown in FIG. 3B relative to the second clutch unit 4. It will be appreciated that in this example the first position is a first rotational position, and the second position is a second, different, rotational position.

In the first position (FIG. 3A), the retaining member 12 is positioned rotationally aligned with the gripping member 4a. Thus, in the first position, the gripping member 4a is forced to be pivoted in a radially outer position. In the first position, the second abutment surface 8 is positioned to be touching or close to the first abutment surface 6. The presence of the retaining member 12 under the gripping member 4a prevents the second abutment surface 8 from being pivoted radially inwards sufficiently to disengage from the first abutment surface 6. Hence, the retaining member 12 in the first position locks the second abutment surfaces 8 in engagement with the first abutment surfaces 6. As the second abutment surface 8 is locked in engagement with the first abutment surface 6, the second clutch unit 4 is rotationally coupled to the first clutch unit 2. Would it not be for the presence of the retaining member 12 preventing the gripping member 4a to move radially inwards, the second abutment surface 8 would disengage from the first abutment surface 6 when a rotational load is applied to the first clutch unit 2 and/or second clutch unit 4.

In the second position (FIG. 3B), the retaining member 12 is positioned rotationally not aligned with the gripping member 4a. Thus, in the second position, the gripping member 4a is free to pivot to a radially inner position. In this example, a biasing force of a resilient member pivots the gripping member 4a with second abutment surface 8 radially inwards sufficiently to disengage from the first abutment surface 6. As a result, the first clutch unit 2 is free to rotate independently of the second clutch unit 4. Thus, in the second position the second clutch unit 4 is decoupled from the first clutch unit 2.

Hence, while the first abutment surface 6 and second abutment surface 8 are adapted to each other so as to allow engaging and disengaging under load, the relative positioning of the second clutch unit 4 and the third clutch unit 60 can selectively in the first position lock the second abutment surface 8 in engagement with the first abutment surface 6, and in the second position release the second abutment surface 8 for disengagement from the first abutment surface 6. It will be appreciated that while the first clutch unit 2 and second clutch unit 4 are decoupled, rotating the third clutch unit 60 from the first position to the second position relative to the second clutch unit 4, will couple the first and second clutch units. While the first clutch unit 2 and second clutch unit 4 are coupled, rotating the third clutch unit 60 from the second position to the first position relative to the second clutch unit 4, will decouple the first and second clutch units.

Changing the position of the third clutch unit 60 relative to the second clutch unit 4 from the first position to the second position, or vice versa, can be performed in many different ways. Changing the position of the third clutch unit 60 relative to the second clutch unit 4 from the first position to the second position can be performed by rotating the third clutch unit 60 relative to the second clutch unit 4 in a forward direction, and changing the position of the third clutch unit 60 relative to the second clutch unit 4 from the second position to the first position can be performed by rotating the third clutch unit 60 relative to the second clutch unit 4 in an opposite, rearward direction. It is also possible to rotate the third clutch unit 60 relative to the second clutch unit 4 from the first position to the second position, and from the second position to the first position in one and the same rotational direction. Instead of rotating, or in addition, the third clutch unit 4 can also be axially translated from the first position to the second position and/or vice versa.

An actuator can be provided for rotating the third clutch unit and/or the second clutch unit from the first position to the second position, and/or from the second position to the first position.

In some examples, the third clutch unit 60 can be arranged for co-rotating with the second clutch unit 4. Therefore, changing the position of the third clutch unit 60 relative to the second clutch unit 4 from the first position to the second position, or vice versa, can be performed by temporarily changing rotation speed of the third clutch unit relative to the second clutch unit, e.g. by temporarily speeding up, braking or halting the second and/or third clutch unit, for rotating from the first position to the second position, or from the second position to the first position.

In this example, an optional bearing 20 is arranged between the second clutch unit 4 and the third clutch unit 60, particularly between the gripping member 4a of the second clutch unit 4 and the retaining member 12 of the third clutch unit 60. Here the bearing is a rolling-contact bearing 20, but it will be appreciated that a sliding-contact bearing may additionally or alternatively be provided. The rolling-contact bearing 20 provides a rolling contact, e.g. instead of a sliding contact, between the gripping member 4a and the retaining member 12, in particular when the retaining member 12 moves the gripping member radially inward and outward, thus facilitating the movement of the third clutch unit 60 relative to the second clutch unit 4 between the first position and the second position and reducing wear. When the retaining member 12 locks the gripping member 4a in engagement with the first clutch unit, the normal forces between the gripping member 4a and the retaining member 12 are proportional to the load exerted on the clutch system, e.g. by the rider. The normal forces and hence the friction forces associated therewith between the gripping member 4a and the retaining member 12 may be reduced by provision of the rolling-contact bearing 20.

The rolling contact bearing 20 may include one or more rollers. In the example of FIGS. 1A and 1B, a roller 20a that is associated with, here rotatably mounted to, the gripping member 4a. The roller 20a may hence be seen as part of the gripping member 4a. The roller 20a is rollingly engaged by the retaining member 12 when the third clutch unit 60 is moved to the first position so as to push the gripping member 4a to a radial outer position for engaging the first clutch unit 2. When the third clutch unit 60 is moved to the second position, the retaining member 12 rollingly engages the roller 20a for enabling the gripping member 4a to be released from the first clutch unit 2 and return to the radially inward position. It will be appreciated that the roller 20a need not necessarily engage the third clutch unit 60 in the second position. In the example of FIGS. 2A and 2B, the roller 20a is associated with, here rotatably mounted to, the third clutch unit 60.

Each sun gear 101, 201, 301, 401 may be associated with a respective clutch 11, 12, 13, 14, such as the exemplary clutch as shown in FIGS. 3A-3B. The respective third clutch units 4 of clutch systems may be rotatably coupled to each other, for example integrated into a single cam shaft. The integrated cam shaft may particularly have a circular cross section, and may be rotatably drivable about an eccentric axis. The integrated cam shaft may be eccentrically arranged relative second clutch units 4 of the clutches 11-14. The second clutch units 4 may also be integrated, wherein the respective gripping members 4a are angularly staggered with respect to each other. Here, each second clutch unit 4 includes only one gripping member wherein the gripping members of different clutches are angularly spaced from each other. The angular staggering may be about 90 degrees. The first clutch units 2 of the different clutches 11-14 are rotatable relative to each other, for allowing relative rotation between the sun gears. Each first clutch unit 2 includes a respective first abutment surface. The integrated cam shaft 60 may hence be used to selectively clutch one of the sun gears 101, 201, 301, 401 to the stationary second axle 10.

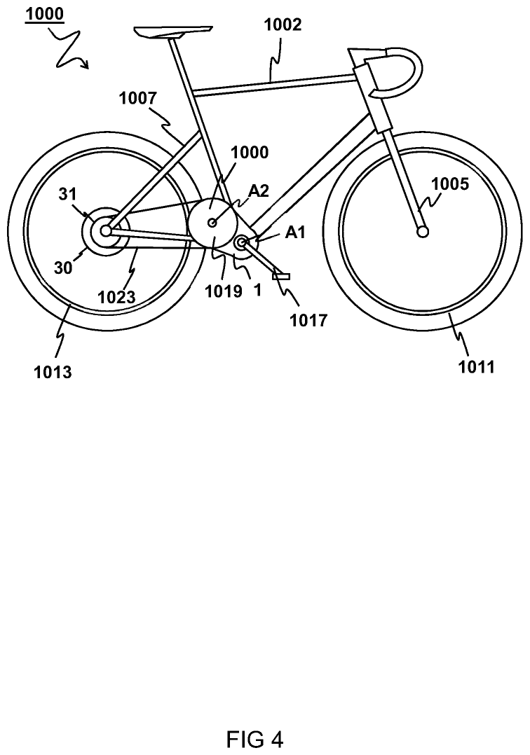

FIG. 4 shows a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. The bicycle 1000 comprises a transmission system 1, in this example embodied as a hub transmission. Alternatively, the transmission system 1 may be embodied as a crank transmission. The bicycle 1000 also comprises a sprocket 31, wherein a chain 1023 threads over the front chain wheel 1019 and the sprocket 31. Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A bicycle crank transmission comprising:
a parallel transmission providing a parallel transmission stage between a parallel transmission input associated with a first axis and a parallel transmission output associated with a second axis;
a planetary transmission providing a planetary transmission stage between a planetary transmission input associated with the second axis and a planetary transmission output associated with the second axis, wherein the planetary transmission is arranged for providing the planetary transmission stage to selectively have one of a plurality of different transmission ratios;
a clutch mechanism arranged for selectively clutching one or more rotational members of the planetary transmission to a stationary part, for selectively transmitting torque by the planetary transmission according to the one of the plurality of different transmission ratios, wherein the clutch mechanism comprises one or more actuatable clutches configured for being coupled and decoupled under load.

2. (canceled)

3. The bicycle crank transmission of claim 1, wherein the planetary transmission has three rotational members, and wherein the clutch mechanism is arranged for clutching one of the rotational members, a sun gear or a ring gear, to the stationary part.

4. The bicycle crank transmission of claim 1, wherein the stationary part includes or is a transmission housing.

5. (canceled)

6. The bicycle crank transmission of claim 1, wherein the clutch mechanism comprises a rotatable cam shaft that extends along the second axis and is arranged for selectively actuating the one or more actuatable clutches by a rotation of the rotatable cam shaft about the second axis relative to the stationary part.

7. The bicycle crank transmission of claim 1, wherein the one or more actuatable clutches include or are form-closed clutches, configured for transferring torque in at least one rotation direction.

8. (canceled)

9. The bicycle crank transmission of claim 6, comprising at least one electric actuator arranged for actuating the rotation of the rotatable cam shaft about the second axis.

10. The bicycle crank transmission of claim 1, wherein the planetary transmission is selectively operable according to a unitary transmission ratio.

11. The bicycle crank transmission of claim 1, wherein the planetary transmission is selectively operable according to a speed-increasing transmission ratio and/or a speed-decreasing transmission ratio, wherein the speed-increasing transmission ratio and the speed-decreasing transmission ratio are inverse to each other.

12. (canceled)

13. The bicycle crank transmission of claim 1, wherein the parallel transmission is arranged for transferring torque according to a speed-increasing transmission ratio.

14. The bicycle crank transmission of claim 1, claim, wherein the parallel transmission stage is formed by a cooperating gear pair having a primary gear being rotatable about the first axis and a secondary gear being rotatable about the second axis.

15. The bicycle crank transmission of claim 14, wherein the primary gear and the secondary gear of the cooperating gear pair cooperate with one another meshingly, or wherein the primary gear and the secondary gear of the cooperating gear pair cooperate with one another non-meshingly, via a respective endless driver member, a chain, or a belt.

16. The bicycle crank transmission of claim 1, comprising a continuously variable transmission providing a fourth transmission stage between a fourth transmission input associated with the second axis and a fourth transmission output associated with the second axis.

17. The bicycle crank transmission of claim 1, comprising a crank transmission housing holding the parallel transmission and the planetary transmission.

18. The bicycle crank transmission of claim 1, comprising an electric propulsion motor arranged for driving the transmission input.

19. The bicycle crank transmission of claim 18, wherein the electric propulsion motor is configured for outputting a maximum output power of at most 10 kW.

20. The bicycle crank transmission of claim 18, wherein the electric propulsion motor is held by a transmission housing.

21. The bicycle crank transmission of claim 17, comprising an electric generator for generating electric power, wherein the electric generator is held by the transmission housing.

22.-31. (canceled)

32. A bicycle comprising the bicycle transmission of claim 1.

33. The bicycle crank transmission of claim 1, comprising a first axle extending along the first axis and a second axle extending along the second axis, wherein the first axle is an input axle of the bicycle crank transmission, and the second axle is a lay axle or an output axle of the bicycle crank transmission.

34. The bicycle crank transmission of claim 33, wherein the stationary part includes or is the second axle that non-rotatably extends along the second axis.
